(19) United States
(12) Patent Application Publication
(10) Pub. No.: US 2008/0311903 A1
(43) Pub. Date: Dec. 18, 2008

(54) Techniques for managing dual-channel wireless devices

(75) Inventor: Danny Levin, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/818,320

(22) Filed: Jun. 14, 2007

(51) Int. Cl. H04Q 7/20

(52) U.S. Cl. 455/426.1

(57) ABSTRACT

Techniques for managing dual-channel wireless devices are described. A dual-channel wireless device may comprise a first transceiver operative to communicate control information over a data channel using a packet-switched network. The dual-channel wireless device may further comprise an enhanced call module communicatively coupled to the first transceiver, the enhanced call module comprising a back-to-back user agent operative to establish a session between the back-to-back user agent and a call terminal using the control information. The dual-channel wireless device may also comprise a second transceiver operative to communicate voice information over a voice channel using a circuit-switched network during the session. Other embodiments are described and claimed.

### BACKGROUND

Some cellular telephones are dual channel devices that typically include both an analog interface and a digital interface. The analog interface may be used for voice communications, such as telephone calls. The digital interface may be used for data communications, such as electronic mail (email) messages, Instant Messaging (IM) and web browsing. With the recent adoption of Voice Over Packet (VOP) or Voice Over Internet Protocol (VoIP) services (collectively referred to as “VoIP”), it may become desirable for a wireless device to support VoIP communications services. Neither the analog interface nor the digital interface for a dual channel cellular telephone, however, is typically capable of originating or terminating VoIP telephone calls without some form of specialized network equipment provided by the cellular radiotelephone system provider or the IP media sub-system (IMS) provider. This may result in increased costs in terms of infrastructure equipment, services or administration.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments may be generally directed to a communications system. The communications system may be used to arrange a call connection or session between a dual-channel wireless device and a call terminal. An example of a dual-channel wireless device may include without limitation a subscriber station for a cellular radiotelephone system having multiple transceivers or interfaces to communicate voice information and data information. An example of a call terminal may include without limitation a VoIP phone, such as a Session Initiation Protocol (SIP) phone.

In one embodiment, for example, the dual-channel wireless device may comprise a first transceiver operative to communicate control information over a data channel using a packet-switched network. The dual-channel wireless device may comprise an enhanced call module communicatively coupled to the first transceiver. The enhanced call module may comprise or be implemented as a back-to-back user agent (B2BUA). The B2BUA may be operative to establish a session between the dual-channel wireless device and a call terminal using the control information. Once the session is established, the dual-channel wireless device may utilize a second transceiver to communicate voice information over a voice channel using a circuit-switched network during the session. In this manner, the dual-channel wireless device may establish a VoIP call using the first transceiver, and communicate voice information using the second transceiver. Other embodiments are described and claimed.

### BRIEF DESCRIPTION OF THE DRAWINGS

FIG. 1 illustrates one embodiment of a communications system.

FIG. 2 illustrates one embodiment of a logic flow.

FIG. 3 illustrates one embodiment of a first message flow.

FIG. 4 illustrates one embodiment of a second message flow.

FIG. 5 illustrates one embodiment of a computing system architecture.

### DETAILED DESCRIPTION

Various embodiments may comprise one or more elements. An element may comprise any feature, characteristic, structure or operation described in connection with an embodiment. Examples of elements may include hardware elements, software elements, physical elements, or any combination thereof. Although an embodiment may be described with a limited number of elements in a certain arrangement by way of example, the embodiment may include more or less elements in alternate arrangements as desired for a given implementation. It is worthy to note that any references to “one embodiment” or “an embodiment” or similar language are not necessarily referring to the same embodiment.

Various embodiments may be directed to a heterogeneous or mixed communications system having both wired and wireless elements, and also implementing packet-switched technologies and circuit-switched technologies. The heterogeneous communications system may include various components, devices or systems capable of originating or terminating calls between a packet-switched network and a circuit-switched network. More particularly, the heterogeneous communications system may be used to arrange a VoIP call or session between a dual-channel wireless device and a call terminal. For example, the heterogeneous communications system may establish a VoIP call using one or more VoIP signaling protocols as defined and promulgated by the Internet Engineering Task Force (IETF) standards organization, such as the Session Initiation Protocol (SIP) as defined by the IETF series RFC 3261, 3265, 3853, 4320 and progeny, revisions and variants. In general, the SIP signaling protocol is an application-layer control and/or signaling protocol for creating, modifying, and terminating sessions with one or more participants. These sessions include Internet Protocol (IP) telephone calls, multimedia distribution, and multimedia conferences. Furthermore, the VoIP call may be established using a data or media format protocol, such as the Real-time Transport Protocol (RTP) and Real-time Transport Control Protocol (RTCP) as defined by the IETF RFC 3550 and progeny, revisions and variants. The RTP/RTCP standard defines a uniform or standardized packet format for delivering multimedia information (e.g., audio and video) over a packet-switched network. Although some embodiments may utilize the SIP and RTP/RTCP protocols by way of example and not limitation, it may be appreciated that other VoIP protocols may also be used as desired for a given implementation.

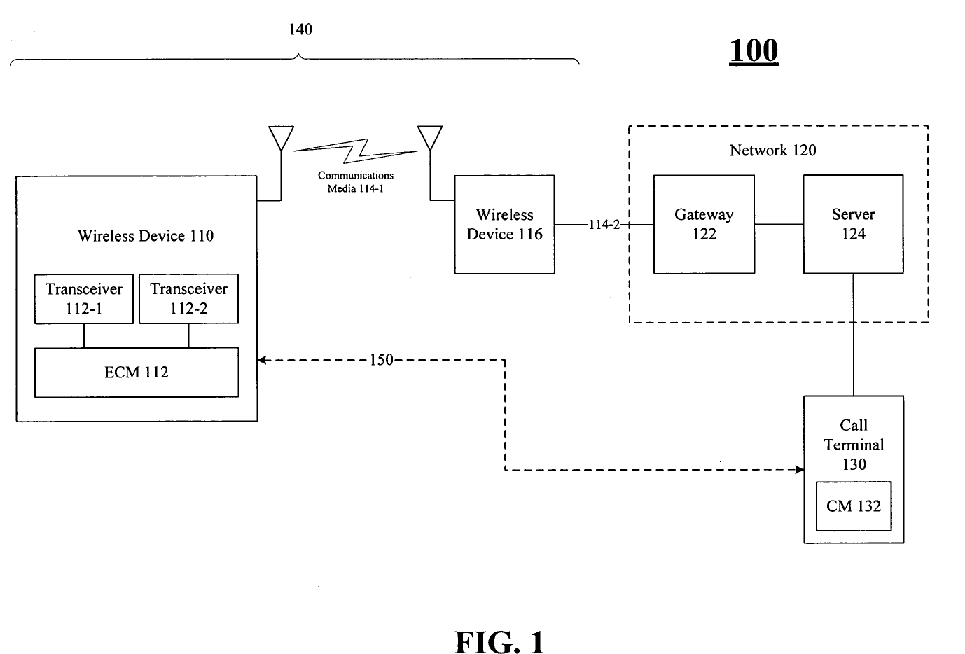

FIG. 1 illustrates a block diagram of a communications system 100. In various embodiments, the communications system 100 may be implemented as a wireless communication system, a wired communication system, or a combination of both. When implemented as a wireless communication system, communications system 100 may include components and interfaces suitable for communicating over wireless communications media 114-1, such as one or more antennas, transmitters, receivers, transceivers, amplifiers, filters, control logic, and so forth. An example of the communications media 114-1 may include a wireless shared media implemented using portions of a wireless spectrum, such as the radio-frequency (RF) spectrum and so forth. When implemented as a wired communications system, communications system 100 may include components and interfaces suitable for communicating over wired communications media 114-2, such as input/output (I/O) adapters, physical connectors to connect the I/O adapter with a corresponding wired communications medium, a network interface card (NIC), disc controller, video controller, audio controller, and so forth. Examples of wired communications media 114-2 may include a wire, cable, metal leads, printed circuit board (PCB), backplane, switch fabric, semiconductor material, twisted-pair wire, co-axial cable, fiber optics, and so forth.

As shown in the illustrated embodiment of FIG. 1, the communications system 100 may include a wireless device 110. The wireless device 110 may include multiple transceivers 112-1-m communicatively coupled to an enhanced call module (ECM) 112. The wireless device 110 may be communicatively coupled to a wireless device 116 via a wireless shared media 114-1. The wireless device 116 may be communicatively coupled to a network 120 via wired communications media 114-2. The network 120 may comprise a gateway 122 and a server 124. The network 120 may be communicatively coupled to a call terminal 130. The call terminal 132 may include a call module 132. Although FIG. 1 illustrates a limited number of elements in a given topology, it may be appreciated that a given implementation may include more or less elements in a different topology as desired for a given set of performance or design constraints. The embodiments are not limited in this context.

In various embodiments, the communications system 100 may include one or more wireless devices 110. The wireless device 110 may comprise, for example, a wireless mobile device. In one embodiment, for example, the wireless device 110 may comprise any physical or logical device capable of establishing a wireless connection with the wireless device 116 via the wireless shared media 114-1. Examples of the wireless device 110 may include without limitation a telephone, a mobile telephone, a cellular telephone, a wireless telephone, a wireless call terminal, a cellular telephone, a combination cellular telephone and personal digital assistant, a handheld computer with a radio, and so forth.

In some embodiments, the wireless device 110 may comprise a dual-channel wireless device having multiple transceivers 112-1-m. In one embodiment, for example, the wireless device 110 may include the transceivers 112-1, 112-2. The first transceiver 112-1 may be implemented to perform data communications. For example, the first transceiver 112-1 may be operative to communicate control information over a data channel using a packet-switched network or technology, such as the Internet. The second transceiver 112-2 may be implemented to perform voice communications or media communications. For example, the second transceiver 112-2 may be operative to communicate voice information over a voice channel using a circuit-switched network or technology, such as a cellular radiotelephone network or PSTN.

In various embodiments, the communications system 100 may include one or more wireless devices 116. The wireless device 116 may comprise, for example, a fixed wireless device. In one embodiment, for example, the wireless device 116 may comprise an access point for a network or communications system, such as a cellular radiotelephone communications system, a wireless local area network (WLAN), a wireless metropolitan area network (WMAN), a wireless wide area network (WWAN), and so forth. Examples for wireless device 116 may include a wireless access point, base station or device B, base station radio/transceiver, router, switch, hub, gateway, and so forth. In one embodiment, for example, wireless device 116 may comprise a base station for a cellular radiotelephone communications system. Although some embodiments may be described with wireless device 116 implemented as a base station by way of example, it may be appreciated that other embodiments may be implemented using other wireless devices as well. Furthermore, although the wireless device 116 is directly connected to the network 120 as shown in FIG. 1, the wireless device 116 may indirectly connect to the network 120 through other network nodes or cellular radio telephone system infrastructure and equipment, such as base stations, mobile subscriber centers, central offices, and so forth.

In one embodiment, the wireless devices 110, 116 may each comprise part of a cellular radiotelephone communications system 140. Examples of cellular radiotelephone communication systems may include without limitation Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) systems such as Wide-band CDMA (WCDMA), CDMA-2000, Universal Mobile Telephone System (UMTS) cellular radiotelephone systems compliant with the Third-Generation Partnership Project (3GPP), and so forth. The embodiments are not limited in this context.

In addition to voice communication services, the wireless devices 110, 116 may be arranged to perform data communications using any number of different wireless protocols over wireless shared media 114-1. In one embodiment, for example, wireless device 110 and wireless device 116 may be arranged to perform data communications using any number of different WWAN data communication services. Examples of cellular data communication systems offering WWAN data communication services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, and so forth. In one embodiment, for example, wireless device 110 and wireless device 116 may also be arranged to communicate using a number of different WLAN data communication services. Examples of suitable WLAN data communication services may include the Institute of Electrical and Electronics Engineers (IEEE) 802.xx series of protocols, such as IEEE 802.11a/b/g/n (WiFi), IEEE 802.16 (WiMAX), IEEE 802.20, and so forth.

In one embodiment, communications system 100 may include the network 120 connected to the wireless device 116 by wired communications media 114-2. The network 120 may comprise additional devices and connections to other networks, including a voice/data network such as the PSTN, a packet network such as the Internet, a LAN, a MAN, a WAN, an enterprise network, a private network, and so forth. In one embodiment, for example, the network 120 may be arranged to communicate control information and media information in accordance with one or more Internet protocols as defined by the Internet Engineering Task Force (IETF), such as the Transmission Control Protocol/Internet Protocol (TCP/IP), for example.

In various embodiments, the network 120 may comprise, among other equipment, a server 124. The server 124 may comprise any electronic device arranged or designed to negotiate, establish, terminate and otherwise manage multiple media streams for multiple communications devices, including one or more VoIP calls made between the call terminal 130 and the wireless device 110. In some cases, the server 124 may comprise a unified messaging server. A unified messaging server may integrate different streams of messages (email, facsimile, voice, video, and so forth) into a single in-box, accessible from a variety of different devices. It differs from simple multimedia email in that unified messaging systems typically try to integrate telephone-based voicemail as well, and to make the unified messaging mailbox accessible from a conventional or cellular phone. In one embodiment, for example, the server 124 may be implemented as a MICROSOFT® OFFICE COMMUNICATIONS SERVER, made by Microsoft Corporation, Redmond, Wash. In addition to providing unified messaging functionality, the MICROSOFT OFFICE COMMUNICATIONS SERVER provides a full SIP server to handle voice phone calls via VoIP, video conferencing and traditional phone networks, and data sharing capabilities. It may be appreciated that other application software capable of supporting VoIP calls may be implemented for the server 124 as well, and the embodiments are not limited in this context.

In one embodiment, for example, the communications system 100 may include a gateway 112. The gateway 112 may operate in conjunction with, or separate from, the server 124 to provide certain VoIP services for the wireless devices 110, 116 and the call terminal 130. In some cases, for example, the gateway 112 may perform various call control operations, such as those typically performed by Internet Protocol (IP) private branch exchange (PBX) systems. Examples of such functionality may include protocol translation, address translation, admission control, call control signaling, call authorization, call management, call transfers, call setup, call teardown, call switching, and so forth. The gateway 112 may further comprise interfaces to convert a conventional telephony call to an IP telephony call or VoIP telephone call. For example, gateway 112 may receive time division multiplexed (TDM) or pulse code modulation (PCM) signals from a circuit-switched network (e.g., a cellular radiotelephone communications system, the PSTN, and so forth), and convert the circuit-switched signals into packets for communication by the packet-switched network 120.

In various embodiments, the network 120 may be communicatively coupled to the call terminal 130. The call terminal 130 may comprise any logical or physical device capable of operating as an end point for a VoIP call. Examples for the call terminal 130 may include without limitation a digital telephone, a packet telephone, a VoIP telephone, a SIP phone, a computer, a personal computer, a laptop computer, a handheld computer, a mobile computer, a server, a workstation, an appliance, a network appliance, and so forth.

In one embodiment, for example, the call terminal 130 may comprise a SIP phone. The SIP operation may be implemented by the client module 132. The client module 132 may comprise installed client software such as a MICROSOFT OFFICE COMMUNICATOR CLIENT, made by Microsoft Corporation, Redmond, Wash. It may be appreciated that other client software capable of supporting VoIP calls may be implemented for the call terminal 130 as well, and the embodiments are not limited in this context.

In general operation, the communications system 100 may establish, facilitate, or otherwise manage VoIP calls having call connections over mixed or heterogeneous networks or technologies, such as a packet-switched network and a circuit-switched network. For example, the wireless device 110 may comprise a cellular telephone with dual channel capabilities. The wireless device 110 may include a digital interface for data communications (e.g., transceiver 112-1) and an analog interface for phone calls (e.g., transceiver 112-2). The digital interface enables the wireless device 110 to operate as a native SIP client in an enterprise network without the ability to terminate VoIP media. The analog interface enables the wireless device 110 to terminate phone calls without the ability to function as a native SIP client. Consequently, the wireless device 110 may be incapable of originating and/or terminating a VoIP call with a VoIP phone, such as the call terminal 130, while reducing or eliminating the need for special enterprise infrastructure equipment and services. The dependency on special enterprise infrastructure may result in higher costs and reduces the ability to implement innovations on a client without corresponding updates to the enterprise infrastructure.

Various embodiments attempt to solve these and other problems. In some embodiments, the wireless device 110 may include the ECM 112. The ECM 112 provides the wireless device 110 with the capability to register as a native SIP client in an enterprise network (e.g., network 120) and terminate SIP VOIP calls, while reducing or eliminating the need for special enterprise infrastructure. The new solution enables the wireless device 110 with dual channels to register directly in a SIP enterprise network and function as an intelligent SIP application by using a B2B technology inside the wireless device 110. The analog interface is shielded from enterprise infrastructure by the application program embedded in the wireless device 110 itself rather than a specialized server in the enterprise infrastructure, and therefore the wireless device 110 can support all features without any dependency on server infrastructure.

In one embodiment, for example, the dual-channel wireless device 110 may comprise the first transceiver 112-1 operative to communicate control information over a data channel using a packet-switched network or technology. The dual-channel wireless device 110 may further comprise the ECM 112 communicatively coupled to the first transceiver 112-1. In one embodiment, for example, the ECM 112 may be implemented as a user agent as defined by one or more SIP standards, such as the IETF RFC 3261 and progeny, revisions and variants. A SIP user agent may comprise a logical entity that can act as both a user agent client (UAC) and user agent server (UAS).

A UAC is a logical entity that creates a new request, and then uses the client transaction state machinery to send it. The role of UAC lasts only for the duration of that transaction. In other words, if a piece of software initiates a request, it acts as a UAC for the duration of that transaction. If it receives a request later, it assumes the role of a UAS for the processing of that transaction. A UAS is a logical entity that generates a response to a SIP request. The response accepts, rejects, or redirects the request. This role lasts only for the duration of that transaction. In other words, if a piece of software responds to a request, it acts as a UAS for the duration of that transaction. If it generates a request later, it assumes the role of a UAC for the processing of that transaction.

In some embodiments, the ECM 112 may be implemented as a specialized form of user agent referred to as a B2BUA. A B2BUA is a logical entity that is a concatenation of a UAC and a UAS. For example, the B2BUA may receive a request and process it as a UAS. In order to determine how a SIP request should be answered, the B2BUA acts as a UAC and generates requests. Unlike a proxy server, the B2BUA maintains dialog state and participates in all requests sent on the dialogs it has established.

In various embodiments, the ECM 112 may implement B2BUA operations to establish a session 150 between the dual-channel wireless device and a call terminal using the control information. A session may comprise, for example, an exchange of data between an association or logical grouping of participants. In one embodiment, the session may comprise a SIP session 150. Once the SIP session 150 is established, the dual-channel wireless device 110 may utilize the second transceiver 112-2 to communicate voice information over a voice channel using a circuit-switched network (switched media) during the session. In this manner, the dual-channel wireless device 110 may establish a VoIP call using the first transceiver 112-1, and communicate voice information using the second transceiver 112-2, while reducing or eliminating the need for special or custom infrastructure equipment.

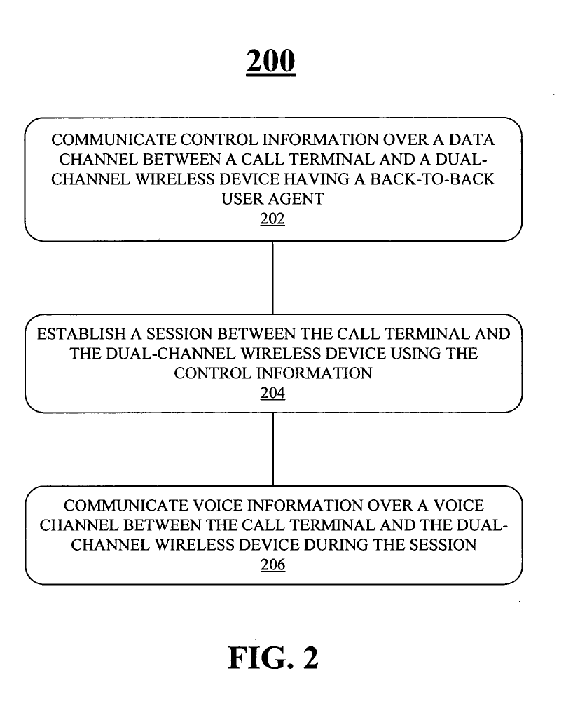

In various embodiments, the ECM 112 allows the wireless device 110 to function as a native SIP registered client within the server 124 infrastructure platform. The ECM 112 may be arranged to support all client features such as make call, answer call, answer call via instant messaging (IM), deflect call, transfer call and join a conference. Furthermore, such operations may be transparent to the infrastructure of the network 120. In order to address an on/off data channel during a phone call, several extensions may be introduced to SIP in order to enable the mediation server/gateway 122 and/or the call terminal 130 to establish an alternate direct SIP route other than through the wireless device 110 when a failure is detected in SIP connectivity with the wireless device 110. This may be accomplished, for example, using the INVITE message structure with replaces. The communications system 100 in general, and the wireless device 110 in particular, may be described in more detail with reference to FIGS. 2-5.

Operations for the communications system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the communications system 100 or alternative elements as desired for a given set of design and performance constraints.

FIG. 2 illustrates a logic flow 200. Logic flow 200 may be representative of the operations executed by one or more embodiments described herein. As shown in logic flow 200, the logic flow 200 may communicate control information over a data channel between a call terminal and a dual-channel wireless device having a back-to-back user agent at block 202. The logic flow 200 may establish a session between the call terminal and the dual-channel wireless device using the control information at block 204. The logic flow 200 may communicate voice information over a voice channel between the call terminal and the dual-channel wireless device during the session at block 206. The embodiments are not limited in this context.

In one embodiment, the logic flow 200 may communicate control information over a data channel between a call terminal and a dual-channel wireless device having a B2BUA at block 202. For example, the call terminal 130 and the transceiver 112-1 for the wireless device 110 may communicate SIP signaling messages over a data channel established via the network 120 and the wireless shared media 114-1. The SIP signaling messages may include the full range of control messages, including messages 1xx through 6xx.

In one embodiment, the logic flow 200 may establish a session between the call terminal and the dual-channel wireless device using the control information at block 204. For example, to facilitate SIP signaling, the ECM 112 may operate as a UAS to receive notification of an incoming call (e.g., a SIP INVITE message), and may operate as a UAC to register with the server 124 of the enterprise network 120 to update address binding operations and location services. The ECM 112 may then respond to the SIP INVITE MESSAGE with the appropriate response message. For example, the ECM 112 may respond with a SIP “200 OK” message to indicate that the request has succeeded.

In one embodiment, the logic flow 200 may communicate voice information over a voice channel between the call terminal and the dual-channel wireless device during the session at block 206. For example, once the VoIP telephone call has been terminated by the ECM 112 using the transceiver 114-1, the call terminal 130 may begin communicating voice information as packet information through the network 120. The gateway 122 may convert the VoIP packets into circuit-switched data, and forward the converted voice information to the wireless device 110. The transceiver 114-2 may be used to receive the voice information where it can be reproduced for the operator, and vice-versa.

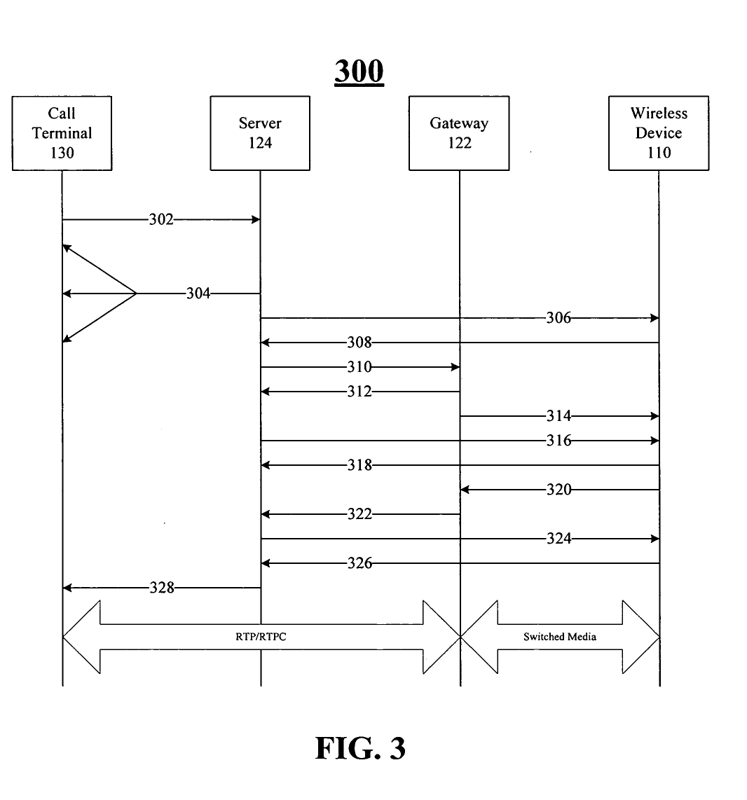

FIG. 3 illustrates one embodiment of a first message flow 300. The message flow 300 may provide an example of a message flow where a VoIP telephone call is initiated by an operator of the call terminal 130 for an operator of the wireless device 110. The VoIP call may traverse the network 120 and the cellular radiotelephone communications system 140 as represented by the wireless devices 110, 116. Assume a caller Bob desires to call a callee Alice. Bob selects contact information for Alice to initiate the VoIP call via his SIP phone represented by the call terminal 130. The call terminal 130 may send a SIP INVITE (Bob to Alice) message to the server 124 of the network 120 as represented by a message 302. The server 124 may receive the SIP INVITE message as a request to establish a SIP session with a communication device used by the callee. The callee may have several communications devices, however, such as an office telephone, a home telephone, a cellular telephone, a telephone operating as a call forwarding end point, and so forth. The server 124 may therefore return several addresses or telephone numbers that may be used to contact the callee as represented by a message 304. One of the telephone numbers may include a cellular telephone number, which is selected by the caller.

Once the cellular telephone number is selected, the server 124 may send a first request to establish a first dialog to a UAS for the wireless device 110 over a data channel via the transceiver 114-1 as represented by a message 306. For example, the server 124 may send a SIP INVITE (Alice) message to the wireless device 110. The wireless device 110 may receive a first request to establish a first dialog from the server 124. For example, the UAS of the ECM 112 of the wireless device 110 may receive the SIP INVITE (Alice) message. In order to generate a response to the SIP INVITE (Alice) message, the UAC of the ECM 112 contacts the server 124. The ECM 112 may generate and send a second request to establish a second dialog from a UAC for the ECM 112 to the server 124 over the data channel via the transceiver 114-1 as represented by a message 308. For example, the message 308 may comprise an INVITE (+14257111111) message. The server 124 may receive the message 308, and send a SIP INVITE (+14257111111) message to the number given in the message 308 to the gateway 122 as represented by a message 310. The wireless device 110 may receive the message 310, and respond with a capabilities offer to the server 124 as represented by a message 312. For example, the capabilities offer may have a format and description as defined by the Session Description Protocol (SDP). In this case, the message 312 may comprise a “183 SDP” message. In this manner capabilities information may be exchanged and negotiated between the server 124 and the gateway 122.

At substantially the same time or shortly thereafter, the gateway 122 communicates with the wireless device 110 to initiate SETUP operations with the wireless device 110 as indicated by a message 314. Once the SETUP operations have been completed, the server 124 and the wireless device 110 may begin to exchange and negotiate capabilities information between each other. For example, the server 124 may send a capabilities offer to the wireless device 110 as represented by a message 316 (e.g., a “183 SDP” message). The UAC of the ECM 112 may receive the SDP offer from the server 124, and send a SDP answer to the server 124 over the data channel via the transceiver 114-1 as represented by a message 318 (e.g., a “183 SDP” message). Once media capabilities have been negotiated and agreed upon, the UAC of the ECM 112 may send a CONNECT message to the server 124 as represented by a message 320. The gateway 122 may receive the message 320, and send a “200 OK” response message to the server 124 in response to the SIP INVITE (+14257111111) message (e.g., the message 310) previously sent by the server 124 to the gateway 122, as represented by a message 322. The server 124 may send a second response that the second dialog is established to the wireless device 110. For example, the server 124 may send a “200 OK” message to the UAC of the ECM 112 of the wireless device 110 over the data channel as represented by a message 324. The “200 OK” message of the message 324 may be in response to the INVITE (+14257111111) message of the message 308 previously sent from the UAC of the ECM 112 of the wireless device 110 to the server 124.

Once the INVITE message sent from the UAC of the ECM 112 has been answered, the UAS of the ECM 112 may respond to the INVITE message previously received from the server 124. For example, the UAS of the ECM 112 may send a first response (e.g., a “200 OK” message) that the first dialog is established to the server 124 over the data channel as represented by a message 326. When the server 124 receives the message 326, the server 124 may send a “200 OK” (Bob) message to the call terminal 130 indicating that a SIP session 150 has been successfully established with the wireless device 110. The call terminal 130 and the wireless device 110 may then begin communicating voice information between each other, with the voice information traversing the network 120 as packets via RTP/RTCP and the cellular radiotelephone communications network as circuit-switched signals via the radio interface, with the gateway 122 performing the appropriate conversion operations.

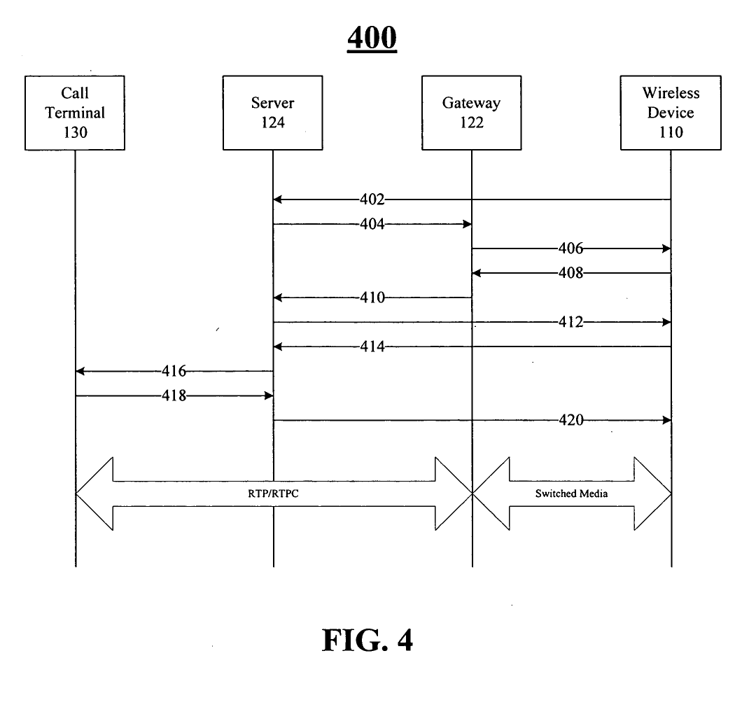

FIG. 4 illustrates one embodiment of a second message flow. The message flow 400 may provide an example of a message flow where a VoIP telephone call is initiated by an operator of the wireless device 110 (e.g., Alice) for the call terminal 130 via the cellular radiotelephone communications system 140 represented by the wireless devices 110, 116 and the network 120. Assume Alice desires to call Bob. As shown in FIG. 4, the wireless device 110 may send a first request to establish a dialog from the UAC of the ECM 112 to the server 124 as represented by a message 402. For example, the message 402 may comprise an INVITE (+14257111111 (without SDP)) message. The server 124 may receive the message 402, and send an INVITE (+14257111111) message to the gateway 122 as represented by a message 404. The gateway 122 may communicate with the wireless device 110 to perform SETUP operations as represented by a message 406. Once the SETUP operations have been completed, the wireless device 110 may send a CONNECT message to the gateway 122 as represented by a message 408. The gateway 122 may receive the message 408, and send a “200 SDP” message to the server 124 as represented by a message 410 in response to the previous INVITE (+14257111111) message received from the server 124. The server 124 may receive the message 410, and send a “200 SDP” message to the wireless device 110 as represented by a message 412 in response to the previous INVITE (+14257111111 (without SDP)) message received from the wireless device 110.

Once the UAC of the ECM 112 of the wireless device 110 receives a first response indicating that the dialog is established from the server 124, the UAC of the ECM 112 may send a second request to establish the session 150 to the server 124 as represented by a message 414. The server 124 may forward the message 414 as an INVITE (Bob) message to the call terminal 130 as represented by a message 416. If Bob answers, the call terminal 130 may send a “200 OK” message to the server 124 as represented by a message 418. The server 124 may then forward the “200 OK” message to the UAC of the ECM 112 of the wireless device 110 as represented by a message 420. Once the SIP session 150 has been successfully established with the wireless device 110, the call terminal 130 and the wireless device 110 may begin communicating voice information between each other, with the voice information traversing the network 120 as packets via RTP/RTCP and the cellular radiotelephone communications network 140 as circuit-switched signals via the radio interface, with the gateway 122 performing the appropriate conversion operations.

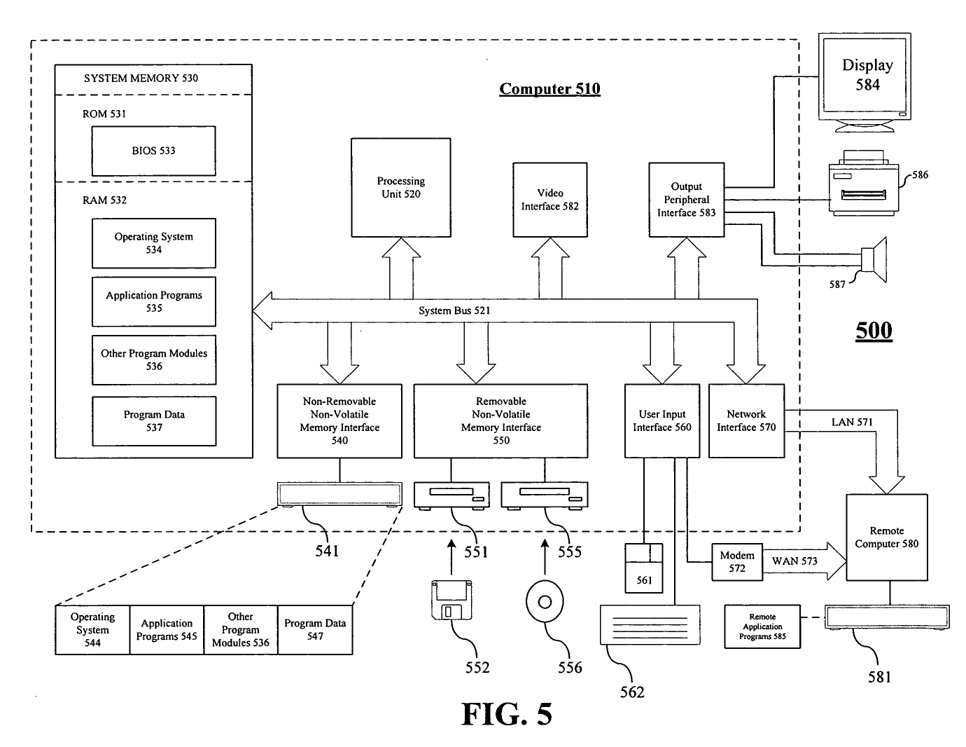

FIG. 5 illustrates a block diagram of a computing system architecture 500 suitable for implementing various embodiments, including various elements of the communications system 100, such as the ECM 112 of the wireless device 110, for example. It may be appreciated that the computing system architecture 500 is only one example of a suitable computing environment and is not intended to suggest any limitation as to the scope of use or functionality of the embodiments. Neither should the computing system architecture 500 be interpreted as having any dependency or requirement relating to any one or combination of components illustrated in the exemplary computing system architecture 500.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 5, the computing system architecture 500 includes a general purpose computing device such as a computer 510. The computer 510 may include various components typically found in a computer or processing system. Some illustrative components of computer 510 may include, but are not limited to, a processing unit 520 and a memory unit 530.

In one embodiment, for example, the computer 510 may include one or more processing units 520. A processing unit 520 may comprise any hardware element or software element arranged to process information or data. Some examples of the processing unit 520 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 520 may be implemented as a general purpose processor. Alternatively, the processing unit 520 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 510 may include one or more memory units 530 coupled to the processing unit 520. A memory unit 530 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 510. The embodiments are not limited in this context.

In one embodiment, for example, the computer 510 may include a system bus 521 that couples various system components including the memory unit 530 to the processing unit 520. A system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 510 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 500. Examples of computer readable media for computing system architecture 500 may include, but are not limited to, volatile and/or nonvolatile memory such as ROM 531 and RAM 532. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 530 includes computer storage media in the form of volatile and/or nonvolatile memory such as ROM 531 and RAM 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/nonvolatile computer storage media. By way of example only, FIG. 5 illustrates a hard disk drive 540 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 584 or other type of display device is also connected to the system bus 521 via an interface, such as a video interface 582. In addition to the monitor 584, computers may also include other peripheral output devices such as speakers 587 and printer 586, which may be connected through an output peripheral interface 583.

The computer 510 may operate in a networked environment using logical connections to one or more remote computers, such as a remote computer 580. The remote computer 580 may be a personal computer (PC), a server, a router, a network PC, a peer device or other common network node, and typically includes many or all of the elements described above relative to the computer 510, although only a memory storage device 581 has been illustrated in FIG. 5 for clarity. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other technique suitable for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other techniques for establishing a communications link between the computers may be used. Further, the network connections may be implemented as wired or wireless connections. In the latter case, the computing system architecture 500 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the communications system 100 and/or computing system architecture 500 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously described. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
communicating control information over a data channel between a call terminal and a dual-channel wireless device having a back-to-back user agent;
establishing a session between the call terminal and the dual-channel wireless device using the control information; and
communicating voice information over a voice channel between the call terminal and the dual-channel wireless device during the session.

2. The method of claim 1, comprising:
receiving a request to establish the session from the call terminal by a unified communications server; and
sending a response that the session is established from the unified communications server to the call terminal.

3. The method of claim 1, comprising:
sending a first request to establish a first dialog from a unified communications server to a user agent server for the dual-channel wireless device over the data channel; and
receiving a first response that the first dialog is established from the user agent server to the unified communications server over the data channel.

4. The method of claim 1, comprising:
receiving a first request to establish a first dialog from a unified communications server by a user agent server for the dual-channel wireless device over the data channel; and
sending a first response that the first dialog is established from the user agent server to the unified communications server over the data channel.

5. The method of claim 1, comprising:
sending a second request to establish a second dialog from a user agent client for the dual-channel wireless device to a unified communications server over the data channel; and
receiving a second response that the second dialog is established from the unified communications server by the user agent client over the data channel.

6. The method of claim 1, comprising:
receiving a session description offer from a unified communications server by a user agent client for the dual-channel wireless device over the data channel; and
sending a session description answer from the user agent client to the unified communications server over the data channel.

7. The method of claim 1, comprising:
sending a first request to establish a dialog from a user agent client for the dual-channel wireless device to a unified communications server; and
receiving a first response that the dialog is established from the unified communications server by the user agent client.

8. The method of claim 1, comprising:
sending a second request to establish the session from a user agent client for the dual-channel wireless device to a unified communications server; and
receiving a second response that the session is established from the unified communications server by the user agent client.

9. An article comprising a storage medium containing instructions that if executed enable a system to:
communicate control information over a data channel between a call terminal and a dual-channel wireless device having a user agent client and a user agent server;
establish a session between the call terminal and the dual-channel wireless device using the control information; and
communicate voice information over a voice channel between the call terminal and the dual-channel wireless device during the session.

10. The article of claim 9, further comprising instructions that if executed enable the system to
receive a request to establish the session from the call terminal by a session initiation protocol server; and
send a response that the session is established from the session initiation protocol server to the call terminal.

11. The article of claim 9, further comprising instructions that if executed enable the system to
send a first request to establish a first dialog from a session initiation protocol server to the user agent server for the dual-channel wireless device over the data channel; and
receive a first response that the first dialog is established from the user agent server to the session initiation protocol server over the data channel.

12. The article of claim 9, further comprising instructions that if executed enable the system to
receive a first request to establish a first dialog from a session initiation protocol server by the user agent server for the dual-channel wireless device over the data channel; and
send a first response that the first dialog is established from the user agent server to the session initiation protocol server over the data channel.

13. The article of claim 9, further comprising instructions that if executed enable the system to
send a second request to establish a second dialog from the user agent client for the dual-channel wireless device to a session initiation protocol server over the data channel; and
receive a second response that the second dialog is established from the session initiation protocol server by the user agent client over the data channel.

14. The article of claim 9, further comprising instructions that if executed enable the system to
send a first request to establish a dialog from the user agent client for the dual-channel wireless device to a session initiation protocol server; and
receive a first response that the dialog is established from the session initiation protocol server by the user agent client.

15. The article of claim 9, further comprising instructions that if executed enable the system to
send a second request to establish the session from the user agent client for the dual-channel wireless device to a session initiation protocol server; and
receive a second response that the session is established from the session initiation protocol server by the user agent client.

16. A system, comprising:
a dual-channel wireless device, the dual-channel wireless device comprising:
a first transceiver operative to communicate control information over a data channel using a packet-switched network;
an enhanced call module communicatively coupled to the first transceiver, the enhanced call module comprising a back-to-back user agent operative to establish a session between the back-to-back user agent and a call terminal using the control information; and
a second transceiver operative to communicate voice information over a voice channel using a circuit-switched network during the session.

17. The system of claim 16, the packet-switched network operative to communicate control information using a session initiation protocol and voice information using a real-time transport protocol.

18. The system of claim 16, comprising a unified communications server operative to communicate with the enhanced call module and the call terminal to establish the session.

19. The system of claim 16, comprising a gateway operative to communicate with a unified communications server, the enhanced call module and the call terminal to establish the session.

20. The system of claim 16, comprising a base station for a cellular radiotelephone system operative to communicate with the dual-channel wireless device over a wireless shared media.
